(19) United States
(12) Patent Application Publication
(10) Pub. No.: US 2004/0212610 A1
(43) Pub. Date: Oct. 28, 2004

(54) Method and apparatus for associating display configuration information with respective displays of an information handling system

(75) Inventor: Daniel L. Hamlin, Round Rock, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/423,248

(22) Filed: Apr. 25, 2003

(51) Int. Cl. G09G 5/00

(52) U.S. Cl. 345/211

(57) ABSTRACT

An information handling system (IHS) is provided wherein the user need not input display configuration information each time a display change is made. The IHS saves display state information that includes which combinations of displays, both active and inactive, have been previously attached to the IHS. Display configuration information is stored in nonvolatile memory for each display state that has been previously encountered by the IHS. After a display change event, if the current display state is the same as a previous display state, then the configuration information associated with the previously display state is retrieved from memory and used to configure the displays currently connected to the IHS.

### BACKGROUND

The disclosures herein relate generally to information handling systems and more particularly to information handling systems which are switched among multiple displays.

As the value and use of information continue to increase, individuals and businesses seek additional ways to process and store information. One option available to users is information handling systems. An information handling system (IHS) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable computer systems typically have integral displays that are not as large as the standalone external displays in everyday office use. Users of portable computer systems sometimes change the display that is used with the computer as the task at hand dictates. For example, when the portable computer is used in an office setting the user typically plugs the portable computer into a docking station which connects to an external display. The docking station's external display, which is generally larger than the portable computer's integral display, is desirable for everyday office use. However, when the computer is used on the road in true portable mode the user typically switches to the integral display. User's switch displays in other circumstances as well. For example, when the portable computer is used to give a presentation in a conference room distant from the office docking station, the portable computer can switch to drive a projection display alone or to drive a projection display and the integral display simultaneously. This is the so-called “SIMUL” mode of display operation in which the displayed image appears on both the integral display and the projection display at the same time.

In some conventional computer systems the user must input a display configuration for a particular display or accept a default display configuration. The display configuration includes for example display resolution, color depth, refresh rate and several other parameters. Different display configurations are often used for different displays coupled to a computer system. This can cause problems for the user when the user switches the computer system from display to display. For example, the user of a portable computer may set the display configuration of the integral display (LCD) to a resolution of 1280×1024. Then when the user switches, by pressing a “hot key” such as FUNCTION F8, to an external display (VGA) the user may set the display configuration to a higher resolution, for example 1600×1200. In this scenario, a problem can be encountered when the user switches back to the integral display (LCD). The user needs to again provide the computer system with display configuration information for the integral display. This can be a time consuming procedure which is annoying to the user.

The Dell Latitude C400 portable computer system introduced in November 2001 addressed some of the shortcomings of the above described conventional computer system. The Dell Latitude C400 included a video driver which remembered the display settings for one of the following display scenarios: LCD only attached, VGA only attached and DVI (Digital Video Interface) only attached. The Latitude C400 remembered settings by saving configuration options for one display in the registry of the operating system. This computer system did not uniquely identify two different display devices and did not save different configuration settings for two of such display devices. The following example is illustrative. The user manually enters display configuration information into a first display and then switches to a second display for which he or she again enters display configuration information. If the user now switches back to the first display, the display configuration settings are restored for the first display. However, if the user then switches back to the second display, the display configuration settings for the second display are not restored. When the Latitude C400 entered a reduced power state such as the S3 and S4 sleep states discussed later, the system restored to the display configuration that was being used prior to entering the sleep state. The

Therefore, what is needed is an information handling system (IHS) which does not require the user to reset the display configuration when the IHS is switched from one display to another display that was previously used.

### SUMMARY

Accordingly, in one embodiment, an information handling system (IHS) is disclosed which includes a processor and a memory coupled to the processor. The IHS also includes nonvolatile storage, coupled to the processor, for storing a plurality of display states including a previous display state and for storing respective display configurations for the plurality of display states. The IHS also includes executable code stored in the nonvolatile storage for detecting a display change event in which the display state of the IHS changes to a current display state, the IHS assuming the display configuration associated with the previous display state if the current display state is the same as the previous display state.

In another embodiment, a method of operating an information handling system (IHS) is disclosed which includes storing, by the IHS, a plurality of display states including a previous display state. The method also includes storing, by the IHS, respective display configurations for the plurality of display states. The method further includes detecting, by the IHS, a display change event in which the display state of the IHS changes to a current display state and determining, by the IHS, if the current display state is the same as a previous display state. The method still further includes assuming, by the IHS, the display configuration associated with the previous display state if the current display state is the same as the previous display state.

A principal advantage of the embodiments disclosed herein is that valuable time is saved when the user switches among multiple displays coupled to an information handling system.

### BRIEF DESCRIPTION OF THE DRAWINGS

FIG. 1 is a block diagram of the disclosed information handling system.

FIG. 2 is a flowchart depicting the processes carried out by the video driver of the disclosed information handling system.

FIG. 3 is a flowchart which illustrates the process flow when the disclosed information handling system encounters a hotkey command to change from one display state to another, the particular hotkey command being processed by system BIOS.

FIG. 4 is a flowchart which illustrates the process flow when the disclosed information handling system encounters a hotkey command to change from one display state to another, the particular hotkey command being processed by an application and relating to an application display change event.

FIG. 5 is a flowchart which illustrates the process flow when the disclosed information handling system enters a power management sleep state such as the S1, S2, S3, S4 and S5 sleep states specified in the ACPI standard.

FIG. 6 is a flowchart which illustrates the process flow when the disclosed information handling system resumes from a power management sleep state such as the S1, S2, S3, S4 and S5 sleep states specified in the ACPI standard.

FIG. 7 is a flowchart which illustrates the process flow of the disclosed information handling system when the display or displays are changed during a lid close event.

FIG. 8 is a flowchart which illustrates the process flow of the disclosed information handling system when the display or displays are changed during a lid open event.

FIG. 9 is a flowchart which illustrates the process flow of the disclosed information handling system when the display or displays are changed during a hot docking event.

FIG. 10 is a flowchart which illustrates the process flow of the disclosed information handling system when the display or displays are changed while a vendor applet is executing.

FIG. 11 is a flowchart which illustrates the process flow of the disclosed information handling system when the display or displays are changed while an operating system applet is executing.

### DETAILED DESCRIPTION

As discussed earlier, it is desirable that an information handling system (IHS) not require the user to re-enter display configuration information each time the IHS switches to another display. Examples of displays to which an IHS can be switched include: LCD (liquid crystal display) only attached, VGA only attached, VGA and LCD both attached (SIMUL), DVI (Digital Visual Interface) attached, and S-video attached. Operating systems such as Microsoft Windows XP will remember display settings for a single display appropriately. For example, the operating system remembers display settings for LCD only and VGA only. When the OS is operating in clone mode (SIMUL) with both displays active, the settings for the displays are overwritten and thus can not be restored.

However when an IHS is switched among multiple displays, problems are encountered requiring the user to reenter display configuration information for prior connected displays. Consider the scenario where the user attaches a first external display to the system and manually sets the configuration to a resolution of 1600×1200. Then the user switches to a second display and sets the configuration to a resolution of 1024×768. If the user then switches the system back to the first display, the resolution of the system will still be 1024×768. The user must manually go back and reset the configuration to the desired resolution for the first display.

This problem is also encountered when the user changes displays as a result of a hot key operation and as a result of a suspend/resume operation. First the hot key scenario is discussed. An operating system such as Microsoft Windows XP when employed on an information handling system will remember display settings for a single display appropriately. For example, assume that an LCD internal display (LCD only) is set to 10×7 and we switch to an external display (CRT only—wherein CRT is the acronym for cathode ray tube.) which is set to 12×10. If we now switch to SIMUL mode which is set to 8×6, then the LCD configuration settings and the CRT only display configuration settings are both set to 8×6.

Another more detailed example of the problem is now given. If the IHS enters a SIMUL mode where both an integral display (LCD alone, for example) and an external display (VGA, for example) are attached, the display settings are defaulted to the lower configuration settings for the single display or the SIMUL setting of the integral display plus the external display. In other words, if a settings change occurs when you move from “LCD alone” to “SIMUL”, then when you return to LCD alone, the setting from SIMUL will remain. An example will help illustrate this hotkey display change problem. Assume that the LCD alone resolution is set to 1400×1050 and that the VGA alone resolution is 1024×768. Operation of the IHS is commenced with operation of the computer system with the LCD alone and resolution is manually set to 1400×1050. The system basic input output system (BIOS) receives a hotkey (Function F8) and switches to VGA only and the resolution is lowered to 1024×768. Now the user hotkeys to enter SIMUL mode with the LCD display and the VGA display both being driven and resolution drops to 1024×768 for both displays. Now the user manually changes the SIMUL display configuration such that the resolution is 800×600. If the user now hotkeys to LCD only, the resolution will be 800×600. Also, if the user hotkeys to VGA only, the resolution will still be 800×600. Thus, when in SIMUL mode, there is no retention of the previous display settings for LCD only or VGA only.

Similar problem are encountered during suspend/resume operations. To conserve energy, an IHS will switch to a lower power consumption state after a predetermined amount of time of inactivity or a predetermined event occurs. The various power states of an IHS are referred to as sleep states and will be discussed later in more detail. The Microsoft Windows XP operating system will restore to the last display configuration that was used before a suspend/resume operation. If you change displays while the IHS is in the suspend state, the display configuration of the previous display is used as the display configuration of the current display. Without user intervention, the operating system will not automatically update the current display configuration to reflect the desired configuration of a current display that was used in the IHS in the past and for which the user had previously provided display configuration information. An example of this problem observed during suspend/resume power management operation is now discussed. Assume that the IHS is configured in an LCD only (VGA not connected) mode set to a resolution of 1024×768. The SIMUL mode with VGA and LCD connected is 1280×1024. The following is the suspend/resume flow. The IHS is booted with the VGA connected. The resolution is then set to 1280×1024 in the SIMUL mode. Subsequently the user shuts down the IHS and restarts the IHS with LCD only. The user sets the resolution to 1024×768 and then suspends the system and reattaches a VGA display while in the suspend state. Subsequently, the user causes the IHS to resume operation. The resolution is observed to be set at 1024×768 for the LCD only.

The disclosed information handling system technology provides an apparatus and methodology for restoring display configurations after events such as display change events, for example hotkey display changes and display changes during lid close/open events. A lid close/open event is when the display portion of a computer, typically a portable computer, is changed from the open position to the closed position. This lid closure event can trigger a reduced power sleep state as will be discussed later. A hotkey display change refers to changing the display from one display to another by pressing a hotkey, such as the Function F8 hotkey, for example. The information handling system uniquely identifies each display which is coupled to the system and stores a display configuration for each display. The information system recognizes when the system switches back to a display which was previously used and applies the corresponding display configuration information. Advantageously, the user is not required to re-input the display configuration information each time the system switches to a display that was previously used.

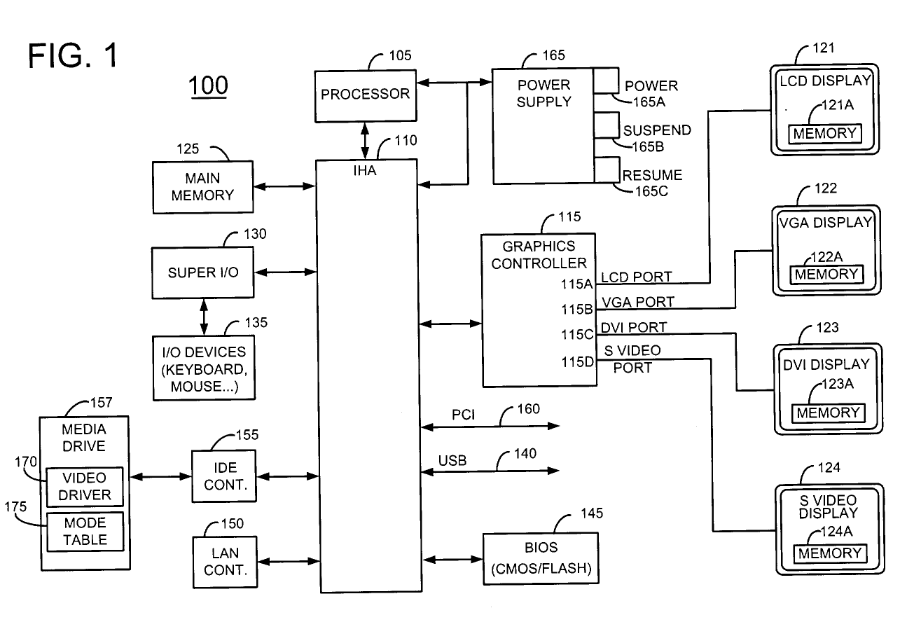

FIG. 1 is a block diagram of the disclosed information handling system 100 which is capable of recognizing previously connected displays and restoring the display configurations previously selected for such displays. For purposes of this disclosure, an information handling system (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

In this particular embodiment, information handling system (IHS) 100 includes a processor 105 such as an Intel Pentium series processor or one of many other processors currently available. An Intel Hub Architecture (IHA) chipset 110 provides IHS system 100 with graphics/memory controller hub functions and I/O functions. More specifically, IHA chipset 110 acts as a host controller which communicates with a graphics controller 115 coupled thereto. Graphics controller 115 is couplable to multiple different monitors such as for example, an integral LCD display 121, an external display 122 (also called VGA or projection display), a DVI display 123 or an S Video display 124. In this embodiment a respective video jack is included in IHS 100 for each of these displays. More specifically, respective jacks are provided at each of LCD port 115A, VGA port 115B, DVI port 115C and S Video port 115D. Other embodiments can have more or fewer video jacks than the number of displays shown. Displays 121, 122, 123 and 124 respectively include display information memories 121A, 122A, 123A and 124A which store display information such as the type of monitor, the resolutions of which the monitor is capable, the refresh rates of which the monitor is capable and other information which identifies or describes the display. The display information includes identification data, such as EDID data, which uniquely identifies each display. More particularly, a display's EDID data is the standard Extended Display Identification Data information which describes the display's capabilities and characteristics, including vendor information, available resolutions, maximum image size, color characteristics, factory pre-set timings, frequency range limits, and character strings for the display name and serial number.

Chipset 110 also acts as a controller for main memory 125 which is coupled thereto. Chipset 110 further acts as an I/O controller hub (ICH) which performs I/O functions. A super input/output (I/O) controller 130 is coupled to chipset 110 to provide communications between chipset 110 and input devices 135 such as a mouse, keyboard, and tablet, for example. A universal serial bus (USB) 140 is coupled to chipset 110 to facilitate the connection of peripheral devices to system 100. System basic input-output system (BIOS) 145 is coupled to chipset 110 as shown. BIOS 145 is stored in nonvolatile memory such as CMOS or FLASH memory.

A local area network (LAN) controller 150, alternatively called a network interface controller (NIC), is coupled to chipset 110 to facilitate connection of system 100 to other information handling systems. Integrated drive electronics (IDE) controller 155 is coupled to chipset 110 so that devices such as media drive 157 can be connected to chipset 110 and processor 105. Devices that can be coupled to IDE controller 155 include CD-ROM drives, DVD drives, hard disk drives and other fixed or removable media drives. An expansion bus 160, such as a Peripheral Component Interconnect (PCI) bus, is coupled to chipset 110 as shown. Expansion bus 160 includes one or more expansion slots (not shown) for receiving expansion cards which provide IHS 100 with additional functionality.

IHS 100 stores display configuration information for each display which becomes connected in the IHS over time. Thus, when the IHS switches for example from display 121, which has a particular display configuration, to display 122 which has another display configuration and then back to display 121, the previously stored configuration for display 121 is retrieved and applied to display 121. In this manner, the images that are then displayed on display 121 are consistent with configuration information previously input by the user for display 121.

For purposes of this document, “display state” refers to a combination of attached active displays and currently attached inactive displays. It is possible that multiple displays are connected to graphics controller 115 but fewer than all connected displays may be actually active displaying content. Many different operational permutations are possible according to the number of displays attached and the number of those displays which are active. For example, it is possible to have “VGA and LCD attached, LCD only active”. This nomenclature means that a VGA display 122 is coupled to VGA port 115B and an LCD display 121 is attached to LCD port 15A. However only the LCD display coupled to LCD port 15A is active. When the user attaches a particular display to the IHS for the first time, the user inputs a desired display configuration into the IHS. The “display configuration” includes all video settings which are configured by the user, or defaulted to by a video driver, in a given display state. These video settings of the display configuration include resolution, color depth, refresh rate, expansion settings, extended desktop settings (on/off and positioning), primary/secondary display configuration and brightness/contrast levels, for example. As just mentioned, multiple displays can be present in a particular display state. A plurality of display states is stored in nonvolatile memory 157. If a particular display state includes one display, then display configuration information corresponding to that one display is stored in nonvolatile memory 157 as part of a display entry for that display state. However, if a particular display state includes more then one display, then respective display information entries are made in memory for each of the displays in the combination of displays which constitute the display state. In other words, the display state entry in memory 157 will include respective display configuration information entries for each of the displays in the display state entry.

When the user switches from a previous display state to a current display state, the IHS looks in memory 157 to determine if that current display state is already stored there. If it is determined that the current display state is already stored in memory 157, then that display state is retrieved along with its constituent display configuration entries for each of the displays in the retrieved display state. These configuration information entries are then applied to the respective displays so that the displays are properly configured.

During the normal operation of the IHS there are many circumstances during which the display can be changed or switched from one display to another. A “display change event” is an event in the operation of the IHS during which the display state is or could be altered. Table 1 below list several such display change events.

TABLE 1

| DISPLAY CHANGE EVENT | DESCRIPTION |
|---|---|
| Hot key processed by BIOS | Press Function F8 to toggle from one |
| | display to another |
| Hot key processed by an | Display changed under the command of |
| application | an application |
| Sleep State | A display change when the IHS is in one |
| | of the S1-S4 sleeps states. (See |
| | Appendix 1) |
| Lid close/open | Display changed when lid of a portable |
| | computer is closed and then opened |
| Hot dock | Display changed when a portable |
| | computer hot docked |
| Vendor applet | Display changed under command from a |
| | vendor's applet |
| OS applet | Display changed under command from |
| | operating system (OS) applet. |

IHS 100 includes a video driver 170 which saves the display configuration of displays that have been connected to the IHS. Video driver 170 is stored in media drive 157 and is executed by processor 105 working in conjunction with graphics controller 115. The display configurations are stored as display configuration information in a mode table 175 which is preferably within the registry of the operating system. Mode table 175 is permanently stored in media drive 157 but can be stored in any nonvolatile storage. Mode table 175 includes multiple display state entries. For each display state entry, there is a display configuration entry for each display of that display state.

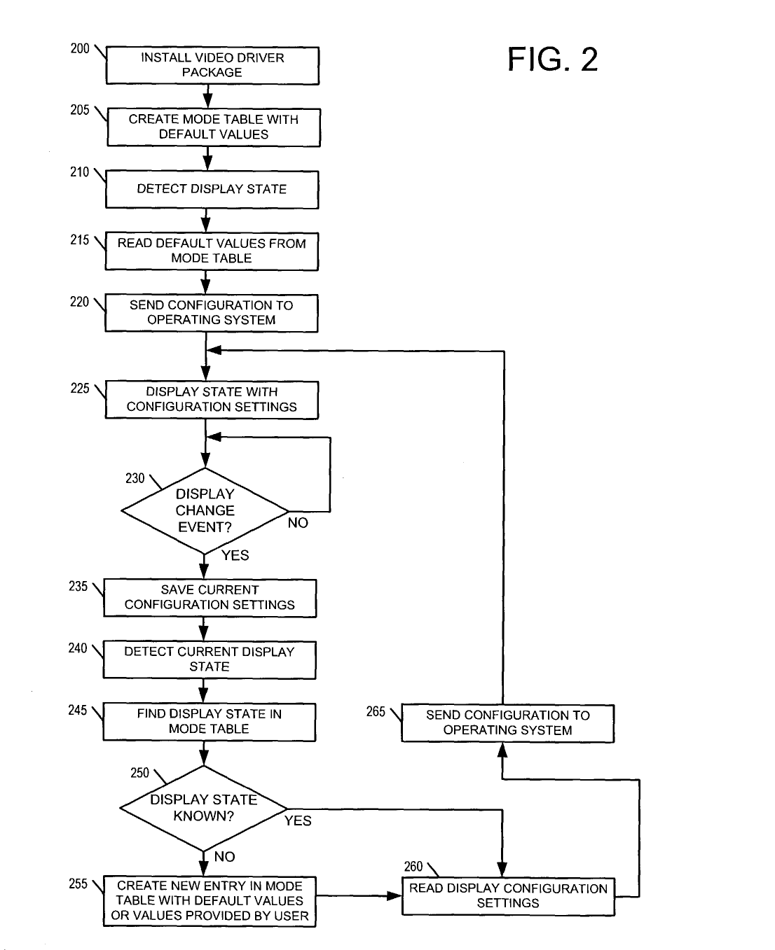

FIG. 2 is a flowchart which illustrates process flow as video driver 170 collects, saves and restores display configurations so that the user need not re-input display configuration information each time he or she switches the IHS to another display or displays, namely to another display state. Video driver 170 remembers a previous video display configuration that the user had set for a previously connected display and restores that display configuration when returning to that display without user interaction. Video driver 170 is installed on IHS 100 as per block 200. A mode table 175 is created with default display configuration settings or values that are stored in media drive 157. The present display state is then detected as per block 210. The display state includes data describing which displays are presently attached to the IHS and which of those are currently active. As explained earlier, the display state which is stored also includes display configuration information for each of the displays in a particular display state. Default configuration information entries or values corresponding to the detected display state are read from the mode table as per block 215. These configuration information values or settings are sent to the operating system of the IHS as per block 220. The operating system instructs graphics controller 115 to activate any attached active displays with the retrieved configuration information. The first time that the IHS encounters a particular display state will result in the IHS using default display configuration settings for the display or displays in that display state. The user will be given an opportunity to provide preferred display configuration information for a particular display state or display as discussed later.

A test is then conducted at decision block 230 to determine if a display change event such as those in Table 1 has occurred. A display change event is an event during which it is possible that a display change may occur. If a display change event has not occurred then decision block 230 continues monitoring for a display change to occur. When a display change event in detected, process flow continues to block 235 at which the current configuration, i.e. the current configuration settings are saved. Now the video driver tests to see if the IHS has been switched to a different display than previously used. It does this by detecting the current display state as per block 240. In more detail, the IHS reads the EDID information of the currently active display or displays. The EDID information uniquely identifies a display and enables the video driver of the IHS to recognize if the current display has previously been attached to the IHS.

If the current display or displays have been previously attached to the IHS then there will be an entry in the mode table uniquely identifying such display or displays along with display configuration information previously specified by the user. The current display state is looked up in the mode table as per block 245. A test is conducted at decision block 250 to determine if the current display state is already known and stored with corresponding display configuration information in the mode table. If the current display state is already known (for example if the combination of an active attached LCD and an inactive VGA display were previously encountered by the IHS), then process flow continues to block 260 at which the particular settings of the display configuration corresponding to the known current display state is retrieved or read from the mode table. In other words, the display state entries and its display configuration information is retrieved. This retrieved configuration information is then sent to the operating system (OS) as per block 265 and the OS applies this retrieved configuration information to restore the display configuration previously set by the user for this particular display state. However, it is noted that if at decision block 250 it was instead determined that the current display state is not known, then process flow continues to block 255 at which a new entry is created in the mode table either with default values or configuration setting provided by the user. Flow then again continues block 260 where the current display configuration settings are read and then sent to the OS at block 260 for application to the current display or displays.

It is noted that the first time the driver is used, namely when the driver is being installed, the following initial configuration rules are followed in this particular embodiment. When the video driver detects a configuration that is not already entered into the mode table; the display configuration adheres to the following rules. The active attached displays are driven in a predetermined order, for example LCD, DVI, VGA, and S-video. If LCD, DVI and VGA displays are detected as being attached, the LCD and DVI displays are driven in a simultaneous mode (SIMUL), namely the same image appears on both displays in the same resolution. The resolution of a newly detected display is set to the lowest of the maximum supported resolutions as denoted by EDID information retrieved from the newly attached display. If a display that will be driven does not contain EDID information, the default resolution is set to 800×600 to provide an initial resolution commonly supported by most displays. For example, if an LCD that supports 1600×1200 is connected in combination with a VGA display that can only support 1024×768, the resolution will be defaulted to 1024×768, the lower of the two resolutions. It is also noted that color depth is defaulted to 32 bits per pixel (bpp) and refresh rate is defaulted to 60 Hz to provide a starting color depth and refresh rate acceptable to most modern displays.

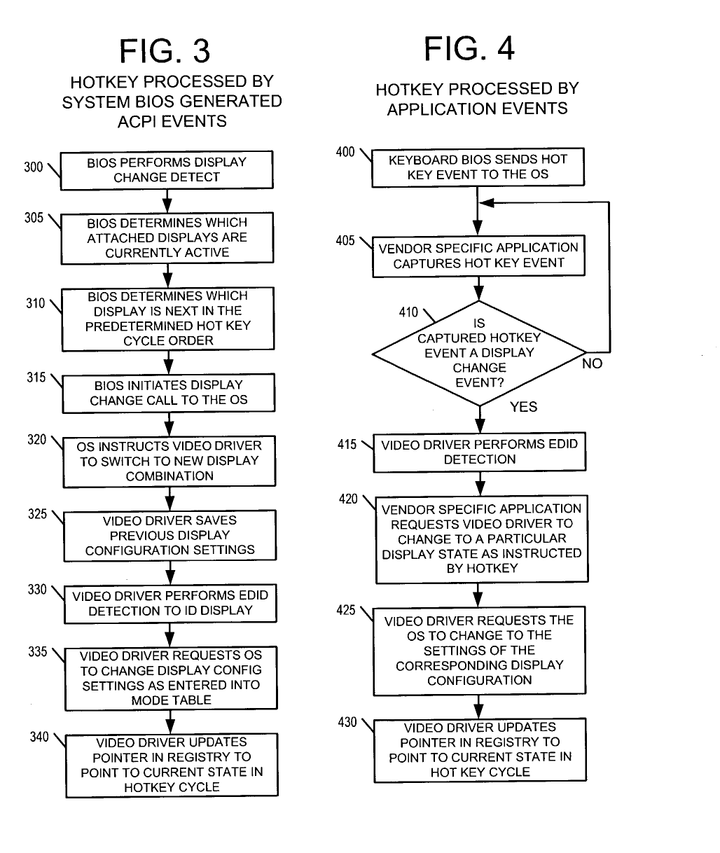

FIG. 3 is a flowchart which illustrates the process flow when IHS 100 encounters a hotkey command (for example, Function F8) to change from one display state to another, for example from LCD to LCD plus VGA. In this particular example, the hotkey command is processed by system BIOS and involves an ACPI display change event. An ACPI display change event is a standard option that is initiated by the BIOS and the BIOS selects the display devices to turn on. This call is sent to the OS and the OS then propagates the call to the graphics driver. This is the how the BIOS can switch displays within an ACPI compliant operating system. In the disclosed embodiment, system BIOS 145 performs a display change detect as per block 300. Block 300 is monitoring for a hotkey event and once such a hotkey event occurs BIOS determines which displays are attached or connected to jacks 115A, 115B, 115C and 115D of the IHS. The BIOS then determines which of the attached displays are currently active as per block 305. Next the BIOS determines which display is next in a predetermined hot key cycle order as per block 310. BIOS then initiates a display change call to the operating system as per block 315. In response the operating system instructs the video driver to change to a new display combination, i.e. a new display state, as per block 320. The video driver saves the previous display configuration settings in nonvolatile storage such as media drive 157 as per block 325. The video driver then performs EDID detection to identify which particular display or displays are attached to the IHS as per block 330. As mentioned earlier the EDID information in each display uniquely identifies that display. By reading this information the IHS can identify a particular display and distinguish that display from others. The video driver then requests the operating system to change display configuration settings used by the graphics controller and attached displays to the display configuration stored in the mode table for the selected display state or display combination. If this is the first time that the IHS is switched to a particular display state, then default display configuration values from the mode table will be used as display configuration information for this newly encountered display state. When the user later changes the display configuration information to his or her preferred settings for this display state, then the IHS again cycles through the process of FIG. 3 so that the new settings will be recorded for use later when this display state is again encountered. The video driver then updates a pointer in the operating system registry to point to the current state in the hotkey cycle.

FIG. 4 is a flowchart which illustrates the process flow when IHS 100 encounters a hotkey command to change from one display state to another wherein the hotkey command is processed by an application and involves an application event. A keyboard BIOS, stored in nonvolatile memory in the IHS, sends a hotkey event to the operating system as per block 400. A vendor specific application captures the hotkey event. Each hardware vendor has a specific application to support their driver and hardware. A vendor specific application is such an application which contains a handler for hotkey events programmed by their application. A test is then conducted at decision block 410 to determine if the captured hotkey event is a display change event. A hotkey display change event is a predefined hotkey sequence (eg. Function F8) where it is expected that the display state will be changed from one display state to another. In one example, when this key sequence is captured, the IHS switches from one display being attached and active to another display which is attached and now becomes active. If decision block 410 finds that the captured hotkey event is not a display change event, for example the hotkey sequence is a CTRL-U which tells a word processor application to underline, then process flow continues back to block 405 where the application continues capturing hotkey events. Decision block 410 continues monitoring hotkey events until it finds a hotkey sequence that is a display change event.

When decision block 410 finds a hotkey sequence that is a display change event, the video driver performs EDID detection on the displays of the new current display state. In this manner it can be determined if this particular display state has already been encountered by the IHS. The application then requests that the video driver change to the particular display state specified by the next display state called for in the predetermined hotkey sequence as per block 420. The video driver then requests that the operating system change to the settings of the display configuration corresponding to this display state as per block 425. Subsequently, the video driver updates the pointer in the registry to point to the now current display state in the hotkey cycle as per block 430.

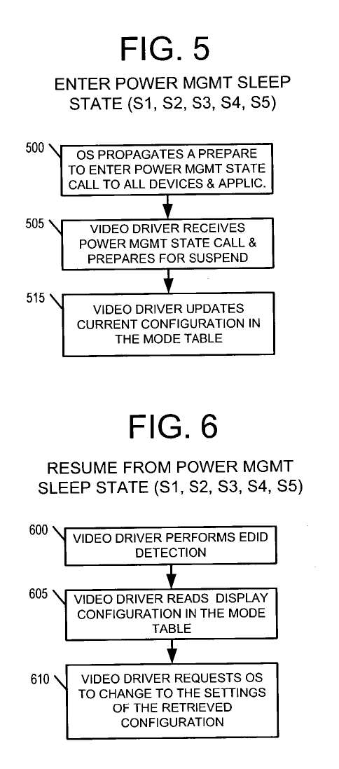

FIG. 5 is a flowchart which illustrates the process flow when IHS 100 enters a power management sleep state such as the S1, S2, S3, S4 and S5 sleep states specified in the ACPI standard. Appendix 1 provides more details regarding the extent of power saving provided by each of these sleep states. One of these sleep states is entered by the IHS after a predetermined amount of time has expired from an input/output event, such as a keystroke for example. Alternatively, a sleep state can be entered up direct command by the user. In either case when IHS 100 is about to enter a sleep state, the operating system propagates a prepare to enter power management state call to all devices and applications as per block 500. The video driver then receives a power management state call and prepares for a suspend operation as per block 505. The video driver then updates the current configuration in the mode table to reflect the settings of the currently active attached displays of the current display state.

To resume from the sleep state, as indicated in the flowchart of FIG. 6, the video driver performs EDID detection of the displays currently attached to the IHS so that it can be determined if the attached displays were previously attached to the IHS as per block 600. The video driver then reads the display configuration of the now attached and active displays from the mode table as per block 605. If the current display or displays of the current display state were previously attached to the IHS then there will be user specified display configuration information in the mode table. This display configuration information for the displays in the current display state is retrieved from the mode table. However, if the current display or displays were not previously attached and active, then a default display configuration will be retrieved from the mode table. The video driver then requests that the operating system change to the settings of the retrieved display configuration information corresponding to the displays of the current display state as per block 610.

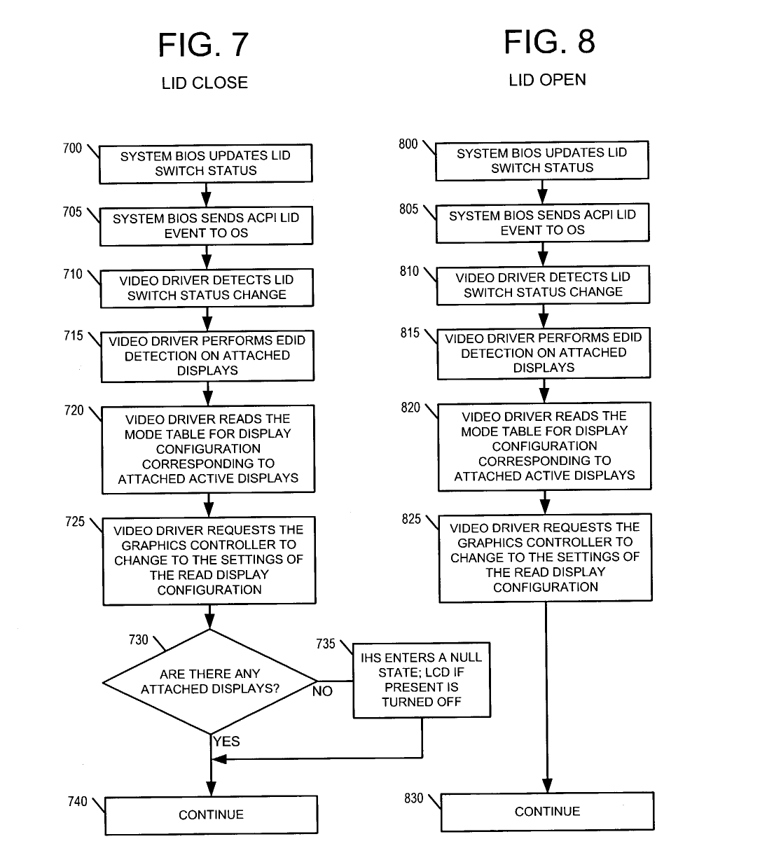

FIG. 7 is a flowchart which illustrates the process flow of IHS 100 when the display or displays are changed during a lid close event. On a portable computer with a base unit including a keyboard and a hinged display assembly or lid, it is possible to change displays when the lid is closed. For example, if the user is working in his or her office with a laptop or notebook computer, the user would typically close the cover or lid and go to a conference room to give a presentation. Once is the conference room, the user generally plugs into a projector display. Thus the display has changed while the lid or cover of the IHS is closed. Many portable IHS's have a lid switch (not shown) which monitors to report when the lid or cover is open and closed. As per block 700 the system BIOS monitors and updates the lid switch status. The system BIOS then sends an ACPI lid event to the operating system as per block 705 so that the operating system is aware of the lid being closed. An ACPI lid event is the closure of the lid or cover such that the display coupled to the IHS can be changed. The video driver detects the lid switch status change from open to closed as per block 710. The video driver then performs EDID detection on the attached displays as per block 715 to determine the identity of the displays attached to the IHS. The video driver then reads the mode table to retrieve the display configuration information corresponding to any active attached displays as per block 720. As mentioned earlier, if a display state has been previously used by the IHS, then the IHS will have a display state entry in the mode table for that display state. That display state will include display configuration information for each of the displays in the display state including for example identification information from the EDID data. If the display has not been previously encountered by the IHS, then default values from the mode table will be used as the display's configuration information. The video driver now requests that graphics controller 115 changes to the settings of the retrieved display configuration information of the current display state as per block 725. A test is then conducted at decision block 730 to determine if any displays are actually attached to the IHS. If it is found that there are no displays attached to the IHS then the IHS enters a null state as per block 735. If an LCD display is present it is turned off. IHS process flow then continues with normal IHS operations as per block 740. If decision block 730 finds that displays are attached to the IHS, then the IHS proceeds directly to continue block 740.

FIG. 8 is a flowchart which illustrates the process flow of IHS 100 when the display or displays are changed during a lid open event. On a portable computer it is also possible to change displays when the cover or lid is open. As per block 800 the system BIOS monitors and updates the lid switch status. The system BIOS then sends an ACPI lid event to the operating system as per block 705 so that the operating system is aware of the lid being open. An ACPI lid event is the open state of the lid or cover of the IHS. The video driver detects the lid switch status which indicates that the lid is open as per block 810. The video driver then performs EDID detection on the attached displays as per block 815 to determine the identity of the displays attached to the IHS. The video driver then reads the mode table to retrieve the display configuration information corresponding to any active attached displays as per block 820. Again, if a display has been previously coupled to the IHS then there will be a corresponding display configuration information entry in the mode table for that display along with its identification information from the EDID data. If the display has not been previously encountered by the IHS, then default values from the mode table will be used as the displays configuration information. The video driver now requests that graphics controller 115 changes to the settings of the retrieved display configuration information as per block 825. IHS process flow then continues with normal IHS operations as per block 830.

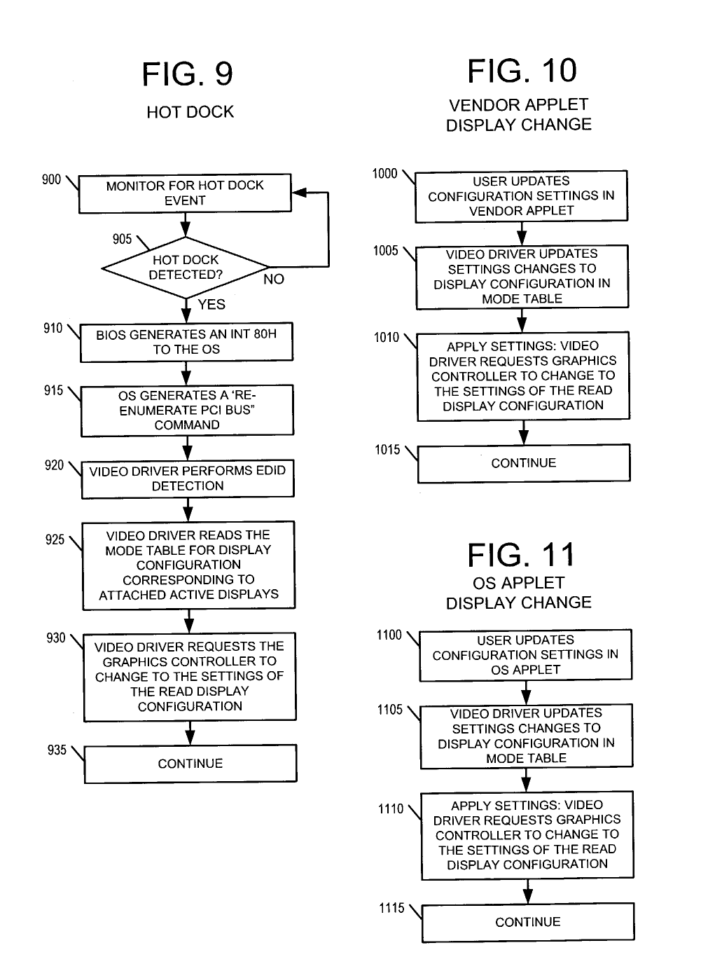

FIG. 9 is a flowchart which illustrates the process flow of IHS 100 when the display or displays are changed during a hot docking event. A hot docking event occurs when a standalone powered-up IHS is taken and coupled to a docking station without the IHS's power being turned off prior to docking. The IHS monitors for such a hot docking event as per block 900. If decision block 905 does not detect a hot docking event, then monitoring for a hot docking event continues. If decision block 905 detects a hot docking event, then the system BIOS generates an interrupt INT 80H to the operating system as per block 910. The INT 80H interrupt is a standard PCI bus re-numeration interrupt. As per block 915 the operating system then generates a re-enumerate PCI bus command which causes the IHS to re-enumerate PCI expansion bus 160 to determine which devices are now coupled to the IHS after it has been hot docked with a docking station. Then the video driver performs EDID detection on the attached display or displays as per block 920. The video driver then reads the mode table to obtain display configuration information for any displays attached to the IHS in the current display state as per block 925. The video driver now requests that graphics controller 115 changes to the settings of the retrieved display configuration information as per block 930. IHS process flow then continues with normal IHS operations as per block 935.

FIG. 10 is a flowchart which illustrates the process flow of IHS 100 when the display or displays are changed during a vendor applet application display change event. A vendor applet display change event is when a display is changed while a vendor applet is being executed. Each hardware vendor generally has a specific application to support their driver and hardware. The vendor applet generally contains a handler for the hotkey events programmed by their application. The user updates display configuration settings while executing a vendor applet as per block 1000. The video driver then saves these settings changes in the display configuration stored in the mode table as per block 1005, thus updating the mode table. To apply the new settings to the IHS, the video driver requests the graphics controller to change the current display settings to those now read from the current display configuration information in the mode table as per block 1010. Process flow then continues as per block 1015 and the IHS continues normal operation.

FIG. 11 is a flowchart which illustrates the process flow of IHS 100 when the display or displays are changed during an operating system (OS) applet display change event. An OS applet display change event is when a display is changed while an OS applet is being executed. An OS applet is the display settings page included in the operating system. This is the main way users change their display settings. The user updates display configuration settings while executing an OS applet as per block 1100. The video driver then saves these settings changes in the display configuration stored in the mode table as per block 1105, thus updating the mode table. To apply the new settings to the IHS, the video driver requests the graphics controller to change the current display setting to those now read from the current display configuration information in the mode table as per block 1110. Process flow then continues as per block 1115 and the IHS continues normal operation.

Advantageously, the disclosed information handling system exhibits video display configuration persistence wherein the video driver remembers a previous display state and corresponding configuration information and returns to that display state and configuration without user intervention.

Although illustrative embodiments have been shown and described, a wide range of modification, change and substitution is contemplated in the foregoing disclosure and in some instances, some features of an embodiment may be employed without a corresponding use of other features. Accordingly, it is appropriate that the appended claims be construed broadly and in manner consistent with the scope of the embodiments disclosed herein.

Appendix 1:

Sleep State Definitions (Section 2.4 ACPI Specification Rev. 2.0)

Sleeping states (Sx states) are types of sleeping states within the global sleeping state, G1. The Sx states are briefly defined below. For a detailed definition of the system behavior within each Sx state, see section 7.3.4, “System\_Sx States.” For a detailed definition of the transitions between each of the Sx states, see section 9.1, “Sleeping States.”

S1 Sleeping State

The S1 sleeping state is a low wake latency sleeping state. In this state, no system context is lost (CPU or chip set) and hardware maintains all system context.

S2 Sleeping State

The S2 sleeping state is a low wake latency sleeping state. This state is similar to the S1 sleeping state except that the CPU and system cache context is lost (the OS is responsible for maintaining the caches and CPU context). Control starts from the processor's reset vector after the wake event.

S3 Sleeping State

The S3 sleeping state is a low wake latency sleeping state where all system context is lost except system memory. CPU, cache, and chip set context are lost in this state. Hardware maintains memory context and restores some CPU and L2 configuration context. Control starts from the processor's reset vector after the wake event.

S4 Sleeping State

The S4 sleeping state is the lowest power, longest wake latency sleeping state supported by ACPI. In order to reduce power to a minimum, it is assumed that the hardware platform has powered off all devices. Platform context is maintained.

S5 Soft Off State

The S5 state is similar to the S4 state except that the OS does not save any context. The system is in the “soft” off state and requires a complete boot when it wakes. Software uses a different state value to distinguish between the S5 state and the S4 state to allow for initial boot operations within the BIOS to distinguish whether or not the boot is going to wake from a saved memory image.

What is claimed is:

1. A method of operating an information handling system (IHS) comprising:
storing, by the IHS, a plurality of display states including a previous display state;
storing, by the IHS, respective display configurations for the plurality of display states;
detecting, by the IHS, a display change event in which the display state of the IHS changes to a current display state;
determining, by the IHS, if the current display state is the same as a previous display state, and
assuming, by the IHS, the display configuration associated with the previous display state if the current display state is the same as the previous display state.

2. The method of claim 1 wherein the display change event it a hotkey sequence.

3. The method of claim 1 wherein the display change event is a power management sleep state.

4. The method of claim 1 wherein the display change event is a lid close event.

5. The method of claim 1 wherein the display change event in a lid open event.

6. The method of claim 1 wherein the display change even is a hot docking event.

7. The method of claim 1 wherein the display change event is an applet display change.

8. The method of claim 1 wherein the determining step is performed by the IHS detecting if EDID information associated with the current display state is the same as EDID information associated with the previous display state.

9. The method of claim 1 wherein a display state includes a plurality of displays.

10. The method of claim 1 wherein the display configuration includes resolution information for displays in the display configuration display state.

11. The method of claim 1 wherein the display configuration includes refresh rate information for displays in the display configuration display state.

12. The method of claim 1 wherein the display configuration includes color depth information for displays in the display configuration display state.

13. The method of claim 1 including assuming, by the IHS, a default display configuration if the current display state is not the same as a previous display state.

14. An information handling system (IHS) comprising:
a processor;
a memory coupled to the processor;
nonvolatile storage, coupled to the processor, for storing a plurality of display states including a previous display state and for storing respective display configurations for the plurality of display states; and
executable code stored in the nonvolatile storage for detecting a display change event in which the display state of the IHS changes to a current display state, the IHS assuming the display configuration associated with the previous display state if the current display state is the same as the previous display state.

15. The information handling system of claim 14 wherein the executable code is a video driver.

16. The information handling system of claim 14 wherein the display change event it a hotkey sequence.

17. The information handling system of claim 14 wherein the display change event is a power management sleep state.

18. The information handling system of claim 14 wherein the display change event is a lid close event.

19. The information handling system of claim 14 wherein the display change event in a lid open event.

20. The information handling system of claim 14 wherein the display change even is a hot docking event.

21. The information handling system of claim 14 wherein the display change event is an applet display change.

22. The information handling system of claim 14 wherein the executable code detects if EDID information associated with the current display state is the same as EDID information associated with the previous display state.

23. The information handling system of claim 14 wherein a display state includes a plurality of displays.

24. The information handling system of claim 14 wherein the display configuration includes resolution information for displays in the display configuration display state.

25. The information handling system of claim 14 wherein the display configuration includes refresh rate information for displays in the display configuration display state.

26. The information handling system of claim 14 wherein the display configuration includes color depth information for displays in the display configuration display state.

27. The information handling system of claim 14 including wherein the executable code causes the IHS to assume a default display configuration if the current display state is not the same as a previous display state.

28. An information handling system (IHS) comprising:
a processor;
a memory coupled to the processor;
nonvolatile storage, coupled to the processor, for storing a plurality of display states including a previous display state and for storing respective display configurations for the plurality of display states; and
a video driver stored in the nonvolatile storage for detecting a display change event in which the display state of the IHS changes to a current display state, the executable code determining if the current display state is the same as a previous display state, the IHS assuming the display configuration associated with the previous display state if the current display state is the same as the previous display state.
